(19) United States
(12) Patent Application Publication
(10) Pub. No.: US 2026/0292738 A1
(43) Pub. Date: Sep. 24, 2026

(54) METHODS FOR ENHANCEMENTS ON UPLINK TRANSMISSION EXTENSION IN GLOBAL NAVIGATION SATELLITE SYSTEM OPERATION

(71) Applicant: MEDIATEK SINGAPORE PTE. LTD., Singapore (SG)

(72) Inventor: Wen TANG, Beijing (CN)

(73) Assignee: MEDIATEK SINGAPORE PTE. LTD., Singapore (SG)

(21) Appl. No.: 19/475,386

(22) PCT Filed: Sep. 25, 2024
(86) PCT No.: PCT/CN2024/120915

§ 371 Date: Oct. 14, 2025

(30) Foreign Application Priority Data
Oct. 25, 2023 (WO) PCT/CN2023/126533

(51) Int. Cl. H04W 56/00; H04B 7/185; H04W 74/0833

(52) U.S. Cl. CPC H04W 56/0045; H04B 7/18513; H04W 74/0833

(57) ABSTRACT

Various solutions for enhancements on uplink (UL) transmission extension in global navigation satellite system (GNSS) operation are described. An apparatus may connect to a network node of a wireless network to operate in a connected state with a GNSS validity duration. Then, the apparatus may determine that an UL transmission is allowed in an extension duration. In particular, the extension duration starts at an expiry of the GNSS validity duration.

### CROSS REFERENCE TO RELATED PATENT APPLICATION(S)

The present disclosure is part of a non-provisional application claiming the priority benefit of PCT Application No. PCT/CN2023/126533, filed 25 Oct. 2023, the content of which herein being incorporated by reference in its entirety.

### TECHNICAL FIELD

The present disclosure is generally related to mobile communications and, more particularly, to enhancements on uplink (UL) transmission extension in global navigation satellite system (GNSS) operation.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, non-terrestrial network (NTN) is introduced as a terminal-satellite direct communication technology based on the new radio (NR) interface. With the integration of satellite network and ground cellular network (e.g., 5th generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

In scenarios with large transmission delay, such as the IoT NTN, to ensure normal system operation, the UE may need a valid GNSS position fix for time and frequency synchronization. According to current 3GPP Release 17 standards, to do GNSS position fix is that the UE needs to have a valid GNSS fix before entering radio resource control (RRC) connected state (also called RRC_CONNECTED mode), and when the GNSS fix becomes outdated in RRC connected state, the UE enters RRC idle state (also called RRC_IDLE mode). Yet, this design is not feasible for UE with potentially long UL transmission because additional re-access to network is needed, which is costing in terms of signaling overhead and delay. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhancements on UL transmission extension in GNSS operation. It is believed that the above-described issue would be avoided or otherwise alleviated by implementing one or more of the proposed schemes described herein.

In one aspect, a method may involve an apparatus connecting to a network node of a wireless network to operate in a connected state with a GNSS validity duration. The method may also involve the apparatus determining that an UL transmission is allowed in an extension duration, wherein the extension duration starts at an expiry of the GNSS validity duration.

In one aspect, a method may involve a network node connecting with an apparatus to allow the apparatus to operate in a connected state with a GNSS validity duration. The method may also involve the network node receiving an UL transmission from the apparatus in an extension duration, wherein the extension duration starts at an expiry of the GNSS validity duration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of UL transmission extension in accordance with an implementation of the present disclosure.

FIG. 2 is a diagram depicting an example scenario of a communication environment in which various solutions and schemes in accordance with the present disclosure may be implemented.

FIG. 3 is a diagram depicting an example scenario of configuring the start time and length of the extension duration X in accordance with an implementation of the present disclosure.

FIG. 4 is a diagram depicting an example table of conditions for UE behavior in UL transmission with or without the extension duration X in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on UL transmission extension in GNSS operation. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

In general, an IoT system is mainly divided into NB-IoT and enhanced machine-type communication (eMTC) based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps).

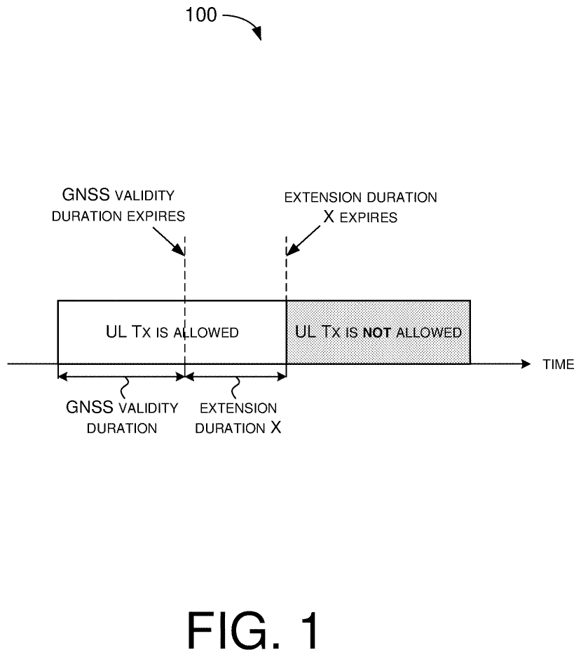

In NTN systems (e.g., IoT NTN systems), due to large time delay and Doppler frequency shift, the UE may need to perform pre-compensation of time delay and frequency offset based on the UE's GNSS position and ephemeris related parameters. To reduce the possible radio link failure during GNSS operation, a GNSS position fix may be re-acquired in long connection time. In 3GPP Release 18, it is agreed that when the frequency error and timing error of the UE's GNSS position are within the frequency and timing error requirements with legacy closed loop time correction, UL transmission may be allowed in an extension duration X after the original GNSS validity duration expires without a GNSS re-acquisition. FIG. 1 illustrates an example scenario 100 of UL transmission extension in accordance with an implementation of the present disclosure. As shown in FIG. 1, the UL transmission (Tx) is not only allowed in the GNSS validity duration, but also allowed in the extension duration X.

However, in current 3GPP Release 18 standards, the detailed procedures about the extension duration X have not been fully discussed and some issues need to be solved. For example, the first issue relates to how to set the start time and length of the extension duration X. The second issue relates to how to perform TA and frequency pre-compensation in the extension duration X. The third issue relates to how to perform TA calculation for PRACH/NPRACH transmission in the extension duration X. The fourth issue relates to how to define the conditions that the UE should not perform UL transmission by considering the extension duration X. The fifth issue relates to how to define procedures subsequent to the expiry of the extension duration X.

In view of the above, the present disclosure is motivated by, but not limited to, an NTN scenario, and accordingly proposes a number of schemes pertaining to enhancements on UL transmission extension in GNSS operation. According to the schemes of the present disclosure, detailed procedures about the extension duration X are proposed to ensure normal operation in NTN systems, including procedures for configuring the start time and length of the extension duration X, procedures for TA and frequency pre-compensation in the extension duration X, procedures for TA calculation for PRACH/NPRACH transmission in the extension duration X, conditions for not allowing the UE to perform UL transmission by considering the extension duration X, and procedures after the expiry of the extension duration X.

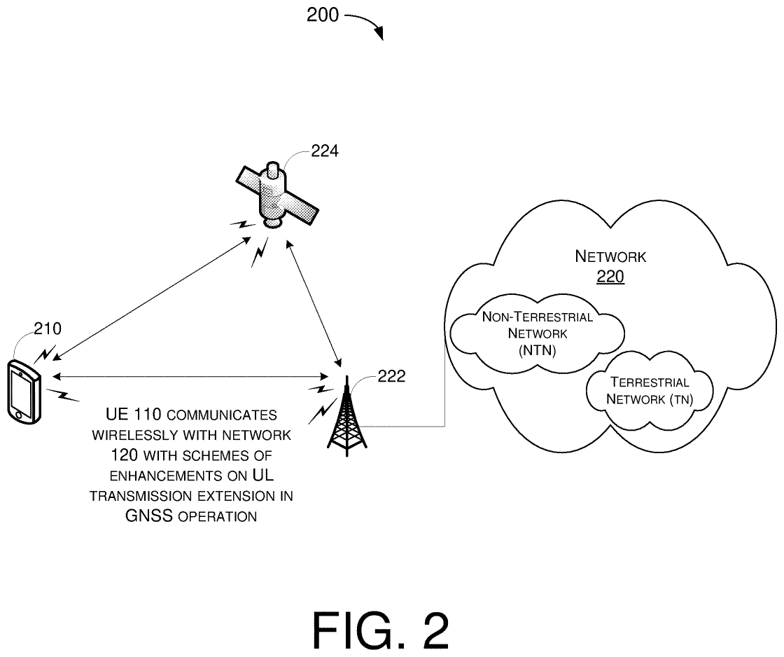

FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including an NTN and a TN) via a terrestrial network node 222 (e.g., an evolved Node-B (eNB), a Next Generation Node-B (gNB), or a transmission/reception point (TRP)) and/or a non-terrestrial network node 224 (e.g., a satellite). For example, the terrestrial network node 222 and the non-terrestrial network node 224 may form an NTN serving cell for wireless communication with the UE 210. Alternatively, the non-terrestrial network node 224 may form an NTN serving cell for wireless communication with the UE 210, without involving the terrestrial network node 222. In such communication environment, the UE 210, the network 220, and the terrestrial network node 222 and/or the non-terrestrial network node 224 may implement various schemes pertaining to enhancements on UL transmission extension in GNSS operation in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under the first proposed scheme of the present disclosure, procedures for configuring the start time and length of the extension duration X in the connected state are proposed to ensure normal operation in NTN systems. Specifically, if the time alignment timer (referred to herein as timeAlignmentTimer) is not configured to be infinity, the extension duration X may start from the time of the expiry of the original GNSS validity duration and end at the time of TAT expiry. Otherwise, if timeAlignmentTimer is configured to be infinity, the extension duration X may start from the time of the expiry of the original GNSS validity duration and may be set with a length value Y (or referred to as ul-TransmissionExtension Value in 3GPP standards for 5G NR) configured by network.

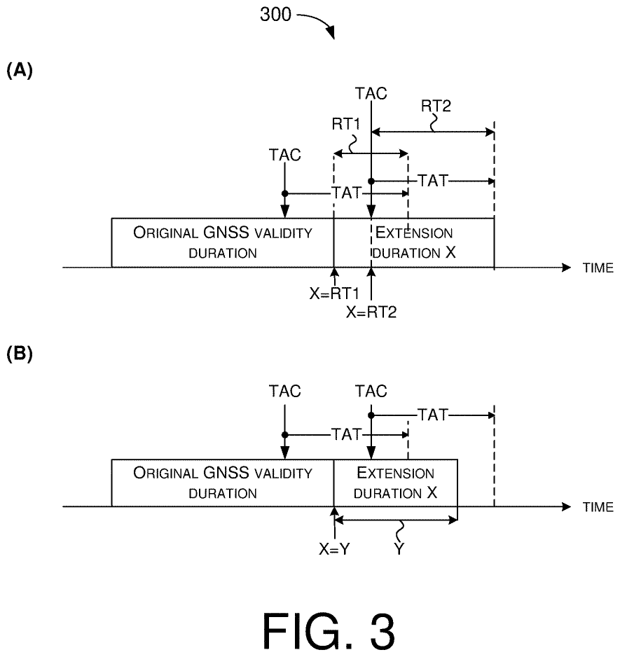

FIG. 3 illustrates an example scenario 300 of configuring the start time and length of the extension duration X in accordance with an implementation of the present disclosure. Part (A) of FIG. 3 depicts the case where timeAlignmentTimer is not configured to be infinity, the extension duration X is started, upon expiry of the GNSS validity duration, with a length value set to the remaining time (denoted as RT1) of timeAlignmentTimer (denoted as TAT). That is, upon indication that the GNSS position has become out-of-date while in RRC_CONNECTED, if the TAT is not configured to be infinity, the extension duration X is started with the length value set to RT1. Additionally, or optionally, if there is a timing advance command (TAC) (e.g., a medium access control (MAC) control element (CE)) received before the TAT expires, the TAT is restarted upon the reception of the TAC, which prolongs the extension duration X with the updated remaining time (denoted as RT2) of the TAT. Part (B) of FIG. 3 depicts the case where the TAT is configured to be infinity, the extension duration X is started, upon expiry of the GNSS validity duration, with a length value (denoted as Y) configured by network. That is, upon indication that the GNSS position has become out-of-date while in RRC_CONNECTED, if the TAT is configured to be infinity, the extension duration X is started with the length value set to Y. Additionally, or optionally, if there is a TAC received before the TAT expires, the TAT is restarted upon the reception of the TAC, but the extension duration X may not be prolonged responsive to the restarting of the TAT.

Under the second proposed scheme in accordance with the present disclosure, procedures for TA and frequency pre-compensation in the extension duration X are proposed to ensure normal operation in NTN systems. TA is required in determining the UL radio frame number for UL transmission from the UE, and for calculating TA, the UE needs to determine the quantity of the UE-derived timing correction (referred to herein as

$${N}_{TA , adj}^{U E} )$$

as one component of TA. Specifically, in the extension duration X, the quantity

$${N}_{TA , adj}^{U E}$$

may be computed by the UE based on the GNSS position (i.e., the UE's position) obtained before the extension duration X is triggered and the serving satellite-ephemeris-related higher-layers parameters if configured, otherwise

$${N}_{TA , adj}^{U E} = 0 .$$

That is, even though the GNSS position obtained before the extension duration X is triggered is outdated during the extension duration X, it may still be utilized for calculating

$${N}_{TA , adj}^{U E}$$

Tor UL transmission within the extension duration X. Additionally, the UE may compute the frequency Doppler shift of the service link, and pre-compensate for the service link in the UL transmissions, by considering the GNSS position obtained before the extension duration X is triggered and the ephemeris.

Under the third proposed scheme in accordance with the present disclosure, procedures for TA calculation for PRACH/NPRACH transmission in the extension duration X are proposed to ensure normal operation in NTN systems. Specifically, the procedures take the accumulated timing error/offset into account for (N) PRACH within the extension duration X.

In some implementations, within the extension duration X, transmission of the uplink radio frame number i from the UE may start at

$${T}_{T A} = ( {N}_{T A} + {N}_{T A , offset} + {N}_{TA , adj}^{c o m m o n} + {N}_{TA , adj}^{U E} ) {T}_{s}$$

seconds before the start of the corresponding downlink radio frame at the UE, where T_{TA} denotes the timing advance between downlink and uplink, N_{TA} denotes the current TA value (i.e., the number of TA adjustments), N_{TA,offset} denotes the fixed offset used to calculate the timing advance,

$${N}_{TA , adj}^{c o m m o n}$$

denotes the network-controlled timing correction,

$${N}_{TU , adj}^{U A}$$

denotes the UL-derived timing correction, and Tₛ denotes the basic time unit for LTE. Within the extension duration X, the UE may not reset N_{TA}=0 for (N) PRACH transmission and in case of random access response, an 11-bit timing advance command, T_{A}, indicates adjustment of the current N_{TA} values by index values of T_{A}=0, 1, 2, . . . , 1536, where an amount of the time alignment is given by N_{TA,new}=N_{TA,old}+T_{A}×16.

In some implementations, before the extension duration X is started, transmission of the uplink radio frame number i from the UE may start at

$${T}_{T A} = ( {N}_{T A} + {N}_{T A , offset} + {N}_{TA , adj}^{c o m m o n} + {N}_{TA , adj}^{U E} ) {T}_{s}$$

seconds before the start of the corresponding downlink radio frame at the UE. Within the extension duration X, the UE may start at

$${T}_{T A} = ( {N}_{T A} + {N}_{T A , offset} + {N}_{TA , adj}^{c o m m o n} + {N}_{TA , adj}^{U E} + {N}_{T A , offsect 2} ) {T}_{s}$$

seconds before the start of the corresponding downlink radio frame at the UE, where N_{TA,offset2} denotes the accumulated offset, and an amount of the time alignment is given by N_{TA,offset2,new}=N_{TA,offset2,old}+N_{TA,old}, and N_{TA,new}=T_{A}×16. N_{TA,offse} is zero at the time when the extension duration X starts.

In some implementations, before the extension duration X is started, transmission of the uplink radio frame number i from the UE may start at

$${T}_{T A} = ( {N}_{T A} + {N}_{T A , o f f s e t} + {N}_{TA , adj}^{c o m m o n} + {N}_{TA , adj}^{U E} ) {T}_{s}$$

seconds before the start of the corresponding downlink radio frame at the UE. Within the extension duration X, the UE may start at

$${T}_{T A} = ( {N}_{T A} + {N}_{T A , offset} + {N}_{TA , adj}^{c o m m o n} + {N}_{TA , adj}^{U E} + {N}_{T A , offset 2} ) {T}_{s}$$

seconds before the start of the corresponding downlink radio frame at the UE, where N_{TA,new}=N_{TA,old}+(T_{A}−31)×16 and N_{TA,offset2} only updates for (N) PRACH transmission, for (N) PRACH transmission an amount of the time alignment is given by N_{TA,offset2,new}=N_{TA,offset2,old}+N_{TA,old}. N_{TA,offset2} is zero at the time when the extension duration X starts.

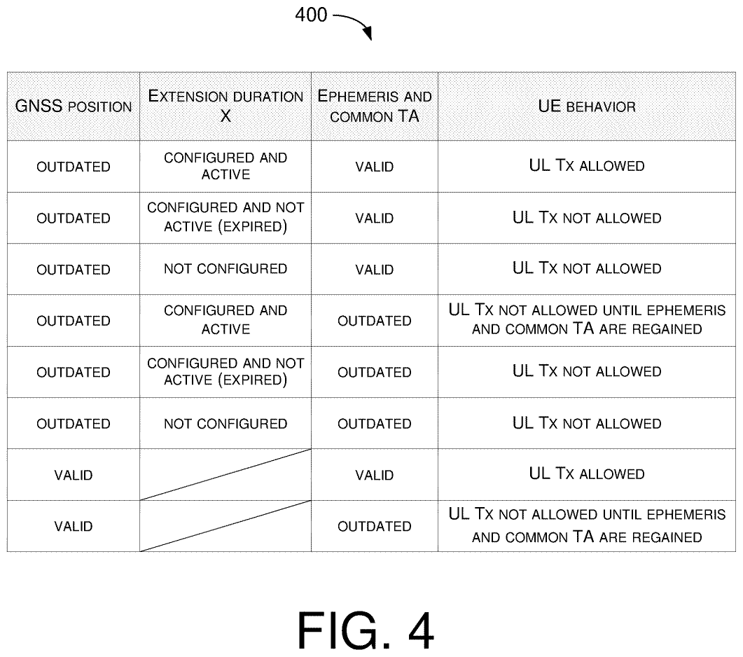

Under the fourth proposed scheme in accordance with the present disclosure, conditions for not allowing the UE to perform UL transmission by considering the extension duration X are proposed to ensure normal operation in NTN systems. Specifically, if the UE is configured to enable the extension duration X, and if the extension duration X expires and/or the UE does not have a valid ephemeris and common TA, the UE should not transmit until one of the following conditions are met: (i) a valid ephemeris and Common TA and GNSS position are regained; and (ii) after GNSS validity duration expires but the extension duration X is not expired, a valid ephemeris and common TA are regained. Additionally, or optionally, if the UE is not configured to enable the extension duration X, and the UE does not have a valid GNSS position and/or valid ephemeris and common TA, the UE should not transmit until they are regained. In other words, if the UE does not have valid ephemeris and common TA, the UE should not transmit until they are regained; and/or if the GNSS position becomes out-dated, the UE should not transmit unless configured with uplink transmissions extension that is active. The overall conditions for UE behavior in UL transmission are summarized in an example table 400 as shown in FIG. 4.

Under the fifth proposed scheme in accordance with the present disclosure, procedures after the expiry of the extension duration X are proposed to ensure normal operation in NTN systems. Specifically, in connected state, upon outdated ephemeris and common TA, the UE may acquire the broadcasted parameters and upon outdated GNSS position where GNSS validity duration and duration X, if configured, expired, the UE may move to idle state. In other words, upon failed GNSS acquisition, the UE may move to idle state if the GNSS position is outdated and uplink transmission extension is not active; and upon outdated GNSS position the UE may move to idle state, unless GNSS acquisition was triggered or uplink transmission extension is active.

### Illustrative Implementations

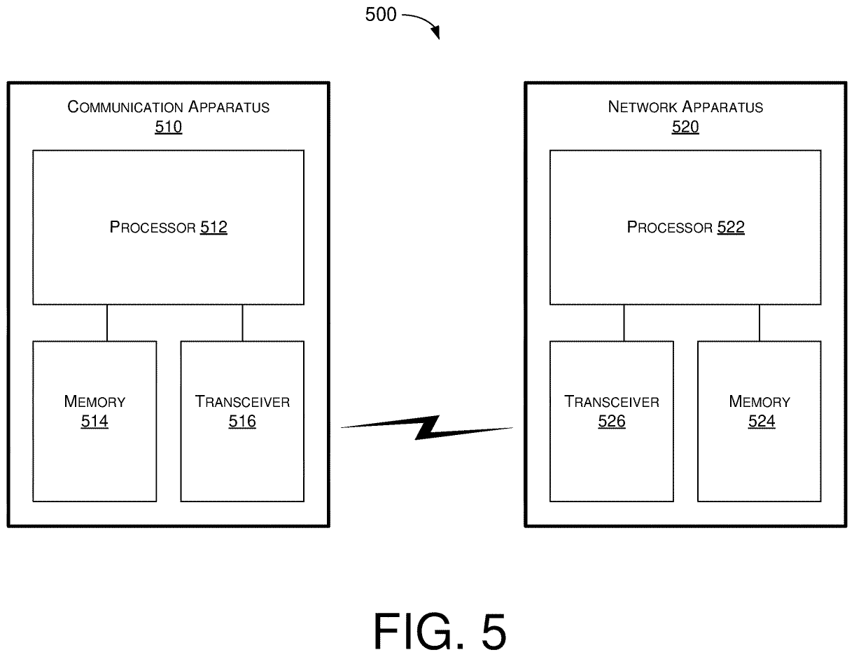

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to enhancements on UL transmission extension in GNSS operation, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a base station (BS), a small cell, a router or a gateway of an NTN. For instance, network apparatus 520 may be implemented in a satellite or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including enhancements on UL transmission extension in GNSS operation, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM).

Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node, is provided below with processes 600 and 700.

### Illustrative Processes

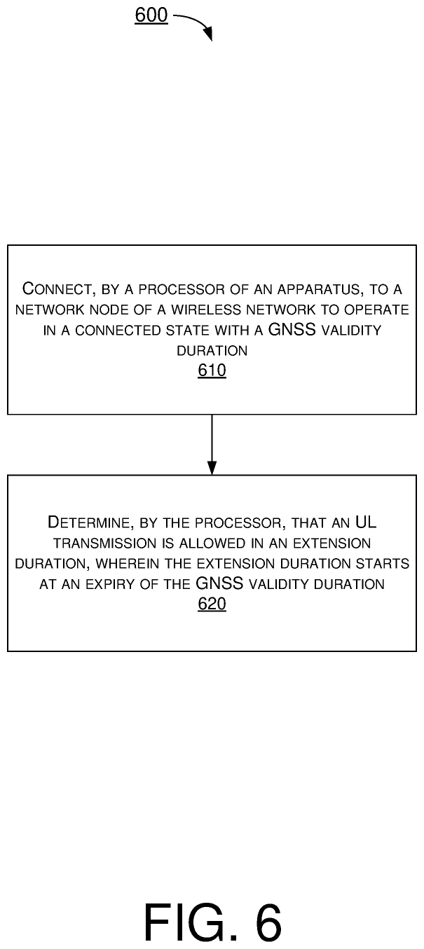

FIG. 6 illustrates an example process 600 in accordance with an implementation of the present disclosure. Process 600 may be an example implementation of above scenarios/schemes, whether partially or completely, with respect to enhancements on UL transmission extension in GNSS operation. Process 600 may represent an aspect of implementation of features of communication apparatus 510. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in communication apparatus 510 or any suitable UE or machine type devices. Solely for illustrative purposes and without limitation, process 600 is described below in the context of communication apparatus 510, as a UE, and network apparatus 520, as a network node. Process 600 may begin at block 610.

At block 610, process 600 may involve processor 512 of communication apparatus 510 connecting, via transceiver 516, to network apparatus 520 of a wireless network to operate in a connected state (e.g., RRC_CONNECTED mode) with a GNSS validity duration. Process 600 may proceed from block 610 to block 620.

At block 620, process 600 may involve processor 512 determining that an UL transmission is allowed in an extension duration, wherein the extension duration starts at an expiry of the GNSS validity duration.

In some implementations, process 600 may further involve processor 512 receiving, via transceiver 516, a configuration of a length value from network apparatus 520, wherein the extension duration is started with the length value in an event that a time alignment timer is configured to be infinity.

In some implementations, the extension duration may be started with a length value set to a remaining time of a time alignment timer in an event that the time alignment timer is not configured to be infinity.

In some implementations, process 600 may further involve processor 512 receiving, via transceiver 516, an indication to extend the UL transmission from network apparatus 520 before the extension duration is expired, and prolonging the extension duration upon the indication with a remaining time of a time alignment timer in an event that the time alignment timer is not configured to be infinity.

In some implementations, the indication may include a TAC in a MAC CE.

In some implementations, process 600 may further involve processor 512 determining that an UL transmission extension is active during the extension duration or that the UL transmission extension is not active when the extension duration is expired or not configured, and switching from the connected mode to an idle state in an event that a GNSS position is outdated, unless the UL transmission extension is active.

In some implementations, process 600 may further involve processor 512 determining to trigger a GNSS acquisition in an event that a GNSS position is outdated and the GNSS acquisition is enabled in the connected state, and switching from the connected state to an idle state in an event that the GNSS position is outdated, unless the GNSS acquisition is triggered.

In some implementations, process 600 may further involve processor 512 determining that the UL transmission is not allowed in the extension duration in an event that the apparatus does not have valid ephemeris and common TA, and determining that the UL transmission is allowed in the extension duration in an event that the apparatus has valid ephemeris and common TA.

In some implementations, process 600 may further involve processor 512 determining that the UL transmission is not allowed after the GNSS validity duration expires in an event that the extension duration is expired and the apparatus has or does not have valid ephemeris and common TA, or determining that the UL transmission is not allowed after the GNSS validity duration expires in an event that the extension duration is not configured and the apparatus has or does not have valid ephemeris and common TA.

In some implementations, process 600 may further involve processor 512 determining that the UL transmission is allowed in the GNSS validity duration, in an event that the apparatus has valid ephemeris and common TA, or determining that the UL transmission is not allowed in the GNSS validity duration, in an event that the apparatus does not have valid ephemeris and common TA.

In some implementations, process 600 may further involve processor 512 determining a TA for the UL transmission during the extension duration, wherein the determining of the TA includes at least one of the following: determining a UE-derived timing correction based on a GNSS position that is obtained before the extension duration is triggered; and applying one or more adjustments of a current N_TA (i.e., N_{TA}) value for a PRACH or NPRACH transmission within the extension duration, wherein the N_TA value indicates a number of TA adjustments.

In some implementations, the GNSS position that is obtained before the extension duration is outdated during the extension duration.

In some implementations, the determining of the TA may further include: computing a frequency Doppler shift of a service link and pre-compensating for the service link in the UL transmission based on the GNSS position that is obtained before the extension duration is triggered.

In some implementations, each of the one or more adjustments of the current N_TA value is indicated by a TAC received from the network node.

In some implementations, the applying of the one or more adjustments of the current N_TA value may further include: updating the current N_TA value based on the one or more adjustments indicated by a TAC from the network node; and determining not to reset the current N_TA value to zero for the PRACH or NPRACH transmission.

In some implementations, the applying of the one or more adjustments of the current N_TA value may further include: updating an accumulated offset based on the one or more adjustments indicated by a TAC from the network node, wherein the accumulated offset is set to zero at a start of the extension duration; and resetting the current N_TA value to zero for the PRACH or NPRACH transmission.

In some implementations, the applying of the one or more adjustments of the current N_TA value may further include: updating the N_TA value based on the one or more adjustments indicated by a TAC from the network node; and setting an accumulated offset to a new N_TA offset value before resetting the current N_TA value to zero for the PRACH or NPRACH transmission, wherein the N_TA offset value is set to zero at a start of the extension duration.

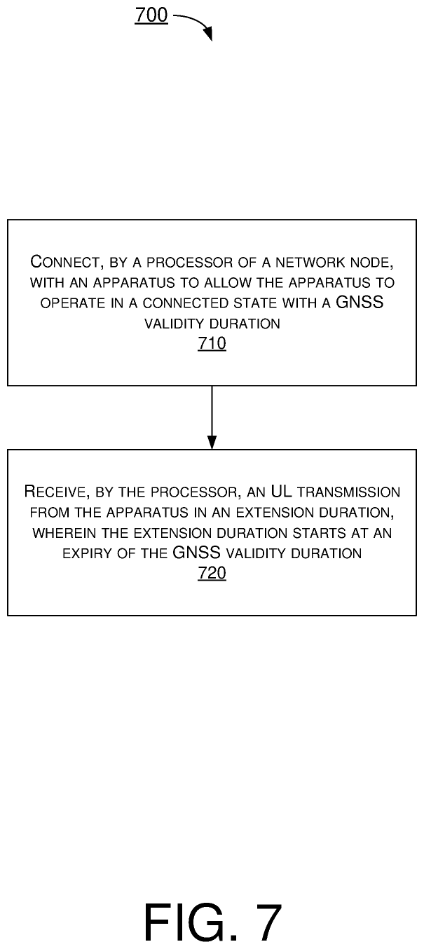

FIG. 7 illustrates an example process 700 in accordance with an implementation of the present disclosure. Process 700 may be an example implementation of above scenarios/schemes, whether partially or completely, with respect to enhancements on UL transmission extension in GNSS operation. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in network apparatus 520 as well as any variations thereof. Solely for illustrative purposes and without limitation, process 700 is described below in the context of communication apparatus 510, as a UE, and network apparatus 520, as a network node. Process 700 may begin at block 710.

At block 710, process 700 may involve processor 522 of network apparatus 520 connecting, via transceiver 526, with communication apparatus 510 to allow communication apparatus 510 to operate in a connected state (e.g., RRC_CONNECTED mode) with a GNSS validity duration. Process 700 may proceed from block 710 to block 720.

At block 720, process 700 may involve processor 522 receiving, via transceiver 526, an UL transmission from communication apparatus 510 in an extension duration, wherein the extension duration starts at an expiry of the GNSS validity duration.

In some implementations, process 700 may further involve processor 522 transmitting, via transceiver 526, a configuration of a length value to communication apparatus 510, wherein the extension duration is started with the length value in an event that a time alignment timer is configured to be infinity.

In some implementations, the extension duration may be started with a length value set to a remaining time of a time alignment timer in an event that the time alignment timer is not configured to be infinity.

In some implementations, process 700 may further involve processor 522 transmitting, via transceiver 526, an indication to extend the UL transmission to communication apparatus 510 before the extension duration is expired, and prolonging the extension duration upon the indication with a remaining time of a time alignment timer in an event that the time alignment timer is not configured to be infinity.

In some implementations, the indication may include a TAC in a MAC CE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to a network node of a wireless network to operate in a connected state with a global navigation satellite system (GNSS) validity duration; and
determining, by the processor, that an uplink (UL) transmission is allowed in an extension duration, wherein the extension duration starts at an expiry of the GNSS validity duration.

2. The method of claim 1, further comprising:
receiving, by the processor, a configuration of a length value from the network node, wherein the extension duration is started with the length value in an event that a time alignment timer is configured to be infinity.

3. The method of claim 1, wherein the extension duration is started with a length value set to a remaining time of a time alignment timer in an event that the time alignment timer is not configured to be infinity.

4. The method of claim 1, further comprising:
receiving, by the processor, an indication to extend the UL transmission from the network node before the extension duration is expired; and
prolonging, by the processor, the extension duration upon the indication with a remaining time of a time alignment timer in an event that the time alignment timer is not configured to be infinity.

5. The method of claim 4, wherein the indication comprises a timing advance command (TAC) in a medium access control (MAC) control element (CE).

6. The method of claim 1, further comprising:
determining, by the processor, that an UL transmission extension is active during the extension duration or that the UL transmission extension is not active when the extension duration is expired or not configured; and
switching, by the processor, from the connected state to an idle state in an event that a GNSS position is outdated, unless the UL transmission extension is active.

7. The method of claim 1, further comprising:
determining, by the processor, to trigger a GNSS acquisition in an event that a GNSS position is outdated and the GNSS acquisition is enabled in the connected state; and
switching, by the processor, from the connected state to an idle state in an event that the GNSS position is outdated, unless the GNSS acquisition is triggered.

8. The method of claim 1, further comprising:
determining, by the processor, that the UL transmission is not allowed in the extension duration in an event that the apparatus does not have valid ephemeris and common timing advance (TA); and
determining, by the processor, that the UL transmission is allowed in the extension duration in an event that the apparatus has valid ephemeris and common TA.

9. The method of claim 8, further comprising:
determining, by the processor, that the UL transmission is not allowed after the GNSS validity duration expires in an event that the extension duration is expired and the apparatus has or does not have valid ephemeris and common TA; or
determining, by the processor, that the UL transmission is not allowed after the GNSS validity duration expires in an event that the extension duration is not configured and the apparatus has or does not have valid ephemeris and common TA; or
determining, by the processor, that the UL transmission is allowed in the GNSS validity duration, in an event that the apparatus has valid ephemeris and common TA; or
determining, by the processor, that the UL transmission is not allowed in the GNSS validity duration, in an event that the apparatus does not have valid ephemeris and common TA.

10. The method of claim 1, further comprising:
determining, by the processor, a timing advance (TA) for the UL transmission during the extension duration, wherein the determining of the TA comprises at least one of the following:
determining a user equipment (UE)-derived timing correction based on a GNSS position that is obtained before the extension duration is triggered; and
applying one or more adjustments of a N_TA value for a physical random access channel (PRACH) or narrowband PRACH (NPRACH) transmission within the extension duration, wherein the N_TA value indicates a number of TA adjustments.

11. The method of claim 10, wherein the GNSS position that is obtained before the extension duration is outdated during the extension duration.

12. The method of claim 10, wherein the determining of the TA further comprises:
computing a frequency Doppler shift of a service link and pre-compensating for the service link in the UL transmission based on the GNSS position that is obtained before the extension duration is triggered.

13. The method of claim 10, wherein the applying of the one or more adjustments of the N_TA value further comprises:
updating the N_TA value based on the one or more adjustments indicated by a timing advance command (TAC) from the network node; and
determining not to reset the N_TA value to zero for the PRACH or NPRACH transmission.

14. The method of claim 10, wherein the applying of the one or more adjustments of the TA value further comprises:
updating an accumulated offset based on the one or more adjustments indicated by a TAC from the network node, wherein the accumulated offset is set to zero at a start of the extension duration; and
resetting the N_TA value to zero for the PRACH or NPRACH transmission.

15. The method of claim 10, wherein the applying of the one or more adjustments of the N_TA value further comprises:
updating the N_TA value based on the one or more adjustments indicated by a TAC from the network node; and
setting an accumulated offset to a N_TA offset value before resetting the N_TA value to zero for the PRACH or NPRACH transmission, wherein the N_TA offset value is set to zero at a start of the extension duration.

16. A method, comprising:
connecting, by a processor of a network node, with an apparatus to allow the apparatus to operate in a connected state with a global navigation satellite system (GNSS) validity duration; and
receiving, by the processor, an uplink (UL) transmission from the apparatus in an extension duration, wherein the extension duration starts at an expiry of the GNSS validity duration.

17. The method of claim 16, further comprising:
transmitting, by the processor, a configuration of a length value to the apparatus, wherein the extension duration is started with the length value in an event that a time alignment timer is configured to be infinity.

18. The method of claim 16, wherein the extension duration is started with a length value set to a remaining time of a time alignment timer in an event that the time alignment timer is not configured to be infinity.

19. The method of claim 16, further comprising:
transmitting, by the processor, an indication to extend the UL transmission to the apparatus before the extension duration is expired; and
prolonging, by the processor, the extension duration upon the indication with a remaining time of a time alignment timer in an event that the time alignment timer is not configured to be infinity.

20. The method of claim 19, wherein the indication comprises a timing advance command (TAC) in a medium access control (MAC) control element (CE).
